(19) United States
(12) Patent Application Publication
(10) Pub. No.: US 2011/0306944 A1
(43) Pub. Date: Dec. 15, 2011

(54) Milk collecting bottle for hand expression

(76) Inventor: Chean-Shui Chen, Taipei (TW)

(21) Appl. No.: 12/802,721

(22) Filed: Jun. 14, 2010

(51) Int. Cl. A61J 1/00

(52) U.S. Cl. 604/346

(57) ABSTRACT

The invention discloses a milk collecting bottle for hand expression, which comprises an opening, a bottle body and a bottle neck connecting the opening with the bottle body which are integrally formed, wherein, the opening is provided with a breast contacting part being capable of attaching to the breast. All parts of the utility model are integrally formed, which can reduce the production cost, and the bottle is very convenient to clean without appearing part losing case. The mother can keep straight naturally during use, the milk can avoid oozing because the action between inclined breast contacting part and anti-oozing flange; moreover, the opening is directly placed on the breast, which does not need to aim the nipple at the container as traditional hand expressing manner while the milk can be effectively collected, therefore, the invention overcomes the shortage of ordinary hand expression; the utility model is further provided with a guide groove so as to pour out the milk, and the utility model can be stored in flattened manner to reduce space for easy carrying, thereby improving the convenience for use.

### FILED OF THE INVENTION

This invention relates to a milk collecting bottle, in particular to a container for collecting mother's milk during hand expression.

### BACKGROUND OF THE INVENTION

Generally speaking, the mother milks by using two hands to press the breast while placing a feeding bottle or other container at hand on the desk or between two legs, or by using one hand to press the breast while using the other hand to hold the container.

However, it is hard to prevent spilling the milk or knocking over the container as a distance is existed between the container and the nipple, the mother need to aim the nipple at the container while pressing the breast; moreover, the mother have to adjust her posture to make the nipple downwards so as to prevent the milk oozed from the nipple flowing along the breast to wet hands or the dress, which not only cause an ache in waist and back, but also can not completely avoid the milk wetting hands or the dress, thereby producing the trouble in hand expression.

### SUMMARY OF THE INVENTION

Aiming at the shortage of prior technology, the utility model provides a new hand expression used milk collecting bottle, which can avoid harmful posture during hand expression, and can effectively collect the milk and prevent the milk from oozing, as well as prevent the milk wetting the hand and the dress during hand expressing process.

In order to realize above purpose, the milk collecting bottle for hand expression of the utility model comprises an opening, a bottle body and a bottle neck, wherein the opening, the bottle body and the bottle neck are integrally formed, the opening is provided with a breast contacting part being capable of attaching to the breast.

The breast contacting part is funnel-shaped soft material (for example: Silicone rubber) incline or perpendicular to horizontal surface.

The breast contacting part is provided with a guide groove so as to pour out collected milk.

The bottle body is in the shape that upper part is smaller than lower part. The bottle body is asymmetrical; dividing by the central shaft of the bottle neck, the volume of the part close to inclined direction of the breast contacting part is bigger than that of the other part.

The inner side of the bottle neck is provided with a flange preventing the milk oozed from the nipple out-flowing the bottle.

The invention has following advantages: all parts of the utility model are integrally formed with soft material, which can reduce the production cost, and the bottle is very convenient to clean without appearing part losing case. The mother can keep straight naturally during use, the milk in the bottle can avoid oozing because the action between inclined breast contacting part and anti-oozing flange; moreover, the opening is directly placed on the breast, which does not need to aim the nipple at the container as traditional hand expressing manner while the milk can be effectively collected, therefore, the utility model overcomes the shortage of ordinary hand expression; the utility model is further provided with a guide groove so as to pour out the milk, and the utility model can be stored in flattened manner to reduce space for easy carrying, thereby improving the convenience for use.

### BRIEF DESCRIPTION OF THE DRAWINGS

The following further illustrates this invention with the drawings:

FIG. 1 is the space diagram of the invention;

FIG. 2 is the right view of the invention;

FIG. 3 is profile chart of A-A direction in the FIG. 2;

FIG. 4 is the front view of the invention;

FIG. 5 is the profile chart of the B-B direction in the FIG. 3;

FIG. 6 is the partial enlarged drawing of C location in the FIG. 5;

FIG. 7 is the use condition drawing of the utility model.

### DETAILED DESCRIPTION OF THE INVENTION

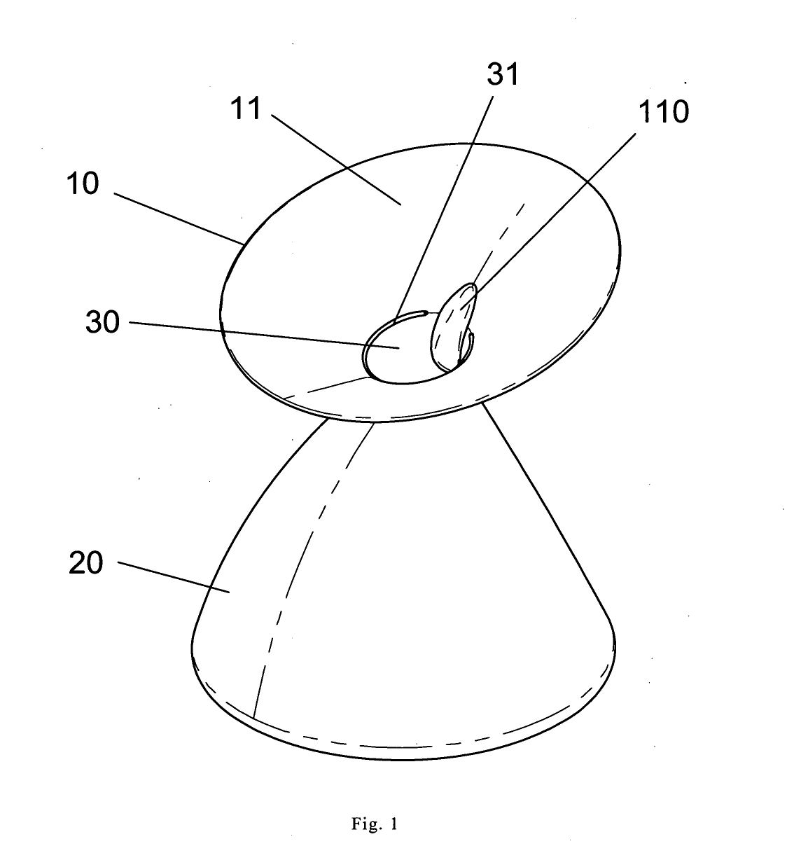

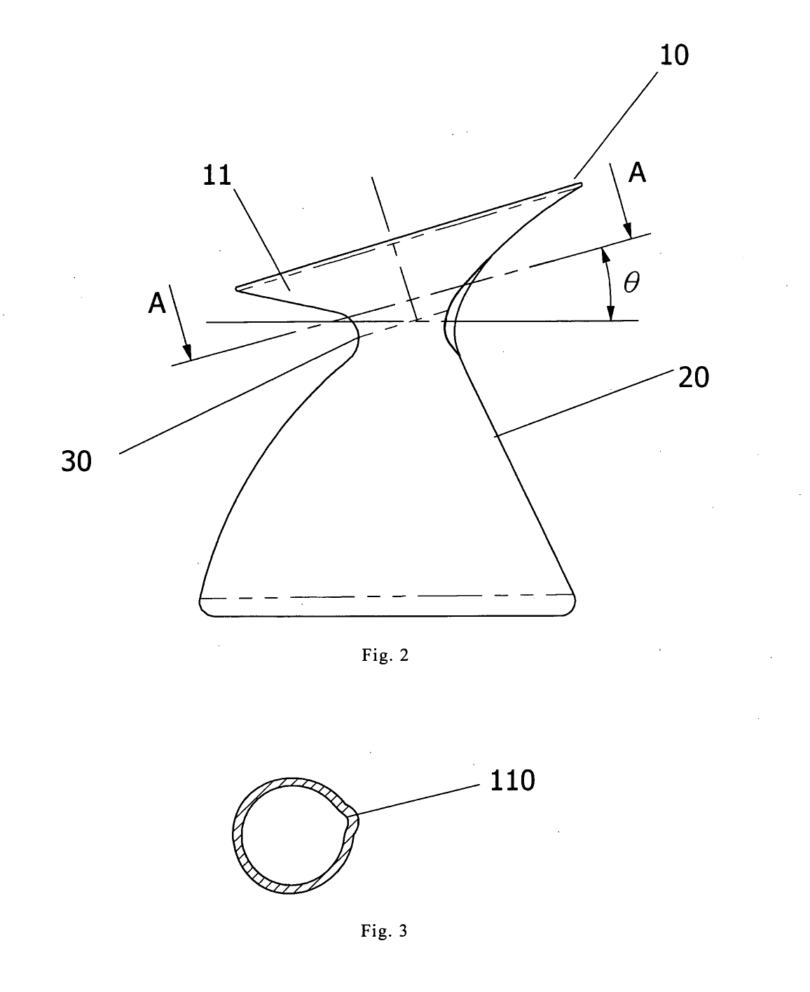

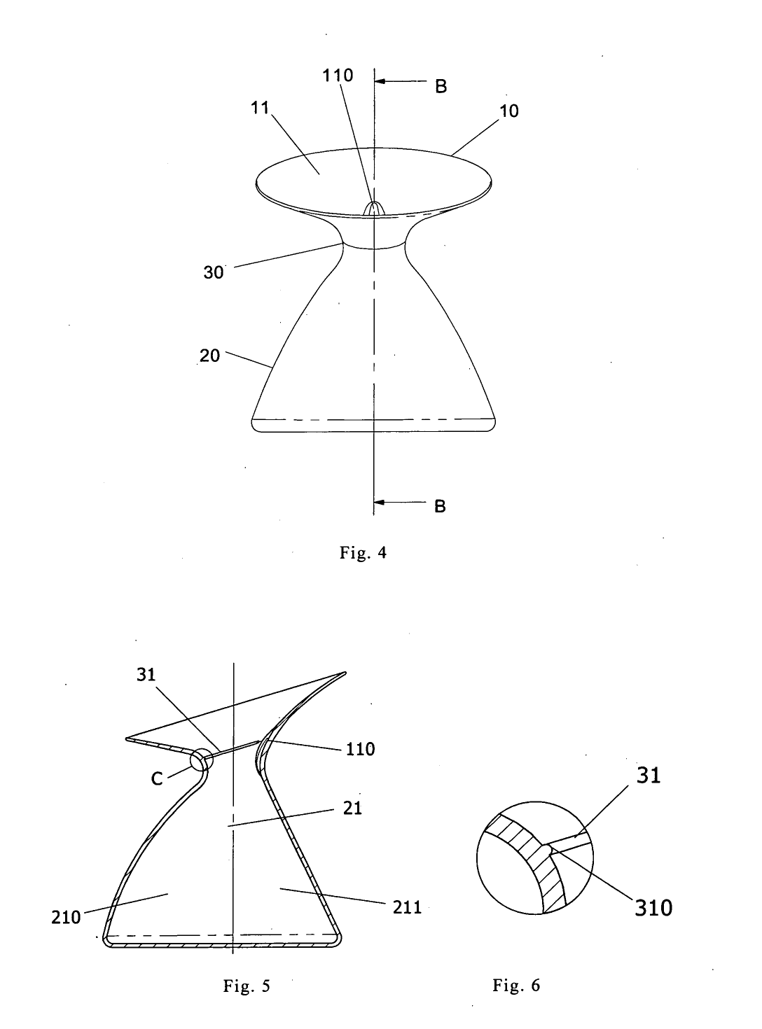

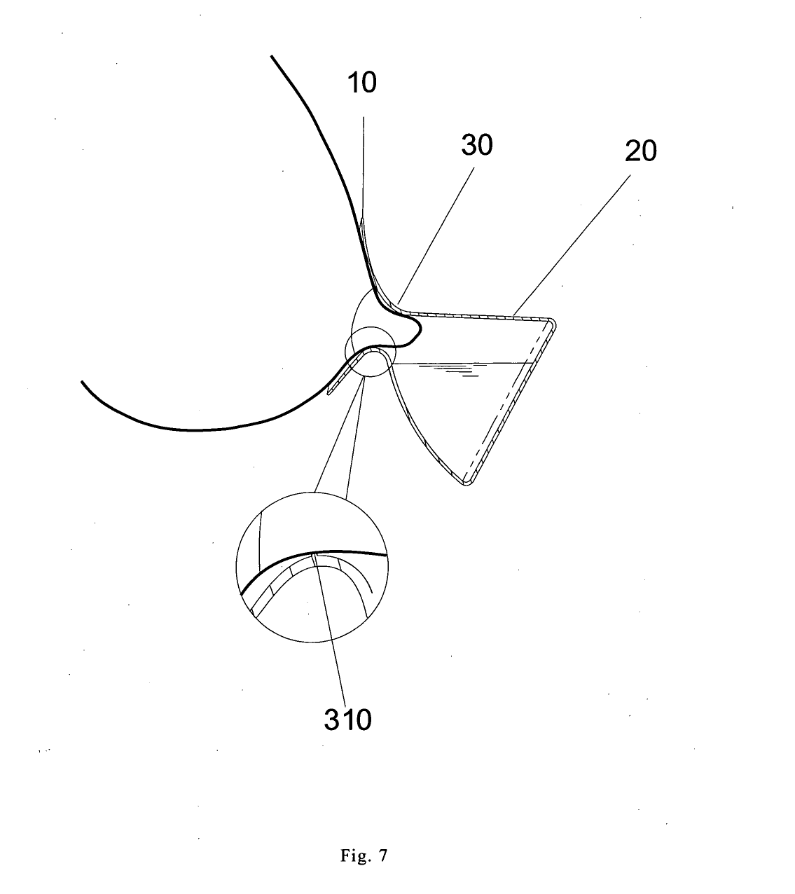

As shown in FIGS. 1 to 3, the milk collection bottle of the utility model comprises an opening 10, a bottle body 20, and a bottle neck 30 connecting the opening 10 with the bottle body 20, wherein the opening 10, the bottle body 20 and the bottle neck 30 are integrally formed. The edge of the opening 30 extends outwards to form a funnel-shaped breast contacting part 11, the breast contacting part 11 is funnel-shaped soft material incline or perpendicular to horizontal surface so as to tightly attach to the breast, the breast contacting part is provided with a guide groove 110. As shown in FIGS. 4 to 6: the bottle body 20 is soft material as well, such that the milk collecting bottle can be stored in flattened manner, and the interior thereof forms a containing space for containing the milk; as shown in FIG. 7: the front half volume 210 of the containing space 21 is bigger than that of rear half volume 211, which can increase the volume utilization rate. The inner surface of the bottle neck 30 is provided with an anti-oozing flange 31, the anti-oozing flange top 310 tightly fits with the root part of the nipple when use, thereby preventing the milk flowing along the breast skin. The opening 10 is placed on the breast when use the utility model, and the nipple is placed in the bottle neck 30, then the milk expressed from the nipple can be directly collected in the bottle body 20. The anti-oozing flange top 310 tightly fits with the root part of the nipple thereby preventing the milk oozed from the nipple flowing along the breast skin to wet the hands or dress.

The milk collecting bottle of the utility model can preventing the milk therein from oozing because of the action between inclined breast contacting part 11 and anti-oozing flange 31 even the mother keeps straight naturally during use. Moreover, the opening 10 is directly placed on the breast, which does not need to aim the nipple at the container as traditional hand expressing manner while the milk can be effectively collected, therefore, the utility model overcomes the shortage of ordinary hand expression; the utility model is further provided with a guide groove 110 so as to pour out the milk, and the utility model can be stored in flattened manner to reduce space for easy carrying, thereby improving the convenience for use.

The above is comparatively better embodiment of the utility model, but the scope of protection of the utility model is not limited on that, all the variations and modifications based on the utility model are in the scope of patent contained in the utility model.

What is claimed is:

1. A milk collecting bottle for hand expression, comprising:
an opening;
a bottle body; and
a bottle neck connecting the opening with the bottle body,
wherein the opening, the bottle body and the bottle neck are integrally formed,
the opening is provided with a breast contacting part being capable of attaching to the breast.

2. The milk collecting bottle for hand expression according to claim 1, wherein the breast contacting part is funnel-shaped soft material incline or perpendicular to horizontal surface.

3. The milk collecting bottle for hand expression according to claim 1, wherein the breast contacting part is provided with a guide groove so as to pour out collected milk.

4. The milk collecting bottle for hand expression according to claim 1, wherein the bottle body is in the shape that upper part is smaller than lower part.

5. The milk collecting bottle for hand expression according to claim 1, wherein the bottle body is asymmetrical, dividing by the central shaft of the bottle neck, the volume of the part close to inclined direction of the breast contacting part is bigger than that of the other part.

6. The milk collecting bottle for hand expression according to claim 1, wherein the inner side of the bottle neck is provided with a flange preventing the milk oozed from the nipple out-flowing the bottle.
